(19) United States
(12) Patent Application Publication
(10) Pub. No.: US 2018/0236753 A1
(43) Pub. Date: Aug. 23, 2018

(54) VEHICULAR POLYMERIC GLAZING

(71) Applicant: FORD GLOBAL TECHNOLOGIES, LLC, Dearborn, MI (US)

(72) Inventors: Richard H. Wykoff, II, Commerce Township, MI (US); Kenneth Edward Nietering, Dearborn, MI (US)

(73) Assignee: FORD GLOBAL TECHNOLOGIES, LLC, Dearborn, MI (US)

(21) Appl. No.: 15/437,046

(22) Filed: Feb. 20, 2017

(51) Int. Cl. B32B 27/08; B32B 27/36; B32B 27/30; B29C 45/00; B29C 45/14; B29C 47/00; B29C 47/06; B29C 37/00; E06B 9/24; B60J 1/00

(52) U.S. Cl. CPC B32B 27/08; B29K 2033/12; B32B 27/308; B29C 45/0001; B29C 45/14336; B29C 47/0004; B29C 47/065; B29C 47/0038; B29C 37/0025; E06B 9/24; B60J 1/001; B32B 2250/03; B32B 2250/24; B32B 2255/10; B32B 2255/20; B32B 2307/412; B32B 2605/006; B32B 27/365

(57) ABSTRACT

A polymeric glazing of a vehicle includes a polycarbonate glazing substrate having interior and exterior vehicle sides, a hardcoat layer applied directly to the interior vehicle side, and a co-extruded film, having polycarbonate and polymethylmethacrylate portions, in direct contact with the exterior vehicle side such that the polymeric glazing lacks a hardcoat layer outside the exterior vehicle side and the polymethylmethacrylate portion forms an outer-most layer of the polymer glazing.

### TECHNICAL FIELD

The disclosure relates to a polymeric glazing to be used in a vehicle and a method of producing the same.

### BACKGROUND

Polymeric glazings have become an attractive alternative to traditional glass or laminated glass vehicle windows. The polymeric glazings include a polycarbonate (PC) substrate with additional films or coatings to improve properties such as weatherability or ultraviolet (UV) radiation resistance and resistance to abrasion. Typically, a hardcoat layer including silicones is added to a PC glazing, the hardcoat layer slows the rate at which the glazing degrades due to exposure to UV radiation. Yet, in time, the hardcoat itself delaminates from adjacent layers and micro-cracks due to development of internal stresses under extended exposure to UV radiation.

### SUMMARY

In at least one embodiment, a polymeric glazing of a vehicle is disclosed. The glazing may include a polycarbonate glazing substrate having interior and exterior vehicle sides. The glazing may further include a hardcoat layer applied directly to the interior vehicle side. The glazing may also include a co-extruded film, having polycarbonate and polymethylmethacrylate portions, in direct contact with the exterior vehicle side such that the polymeric glazing lacks a hardcoat layer outside the exterior vehicle side and the polymethylmethacrylate portion forms an outer-most layer of the polymer glazing. The polycarbonate portion of the film and the exterior vehicle side may be in direct contact with each other. The glazing may further include an abrasion resistant layer in direct contact with the hardcoat layer on the interior side, an abrasion resistant layer in direct contact with the polymethylmethacrylate portion of the film on the exterior side, or both. The abrasion resistant layer may include silicon. The polymethylmethacrylate portion may form about 5% to 10% of an overall thickness of the co-extruded film. The abrasion resistant layer on the exterior side and the hardcoat layer on the interior side may sandwich the polycarbonate glazing substrate and the co-extruded film therebetween. The hardcoat layer may be a single hardcoat layer on the interior side.

In another embodiment, an automotive polymeric glazing is disclosed. The glazing may include a polycarbonate glazing substrate having interior and exterior sides. The glazing may also include a co-extruded film, having polymethylmethacrylate and polycarbonate portions, in direct contact with the exterior side of the polycarbonate substrate. The glazing may also include a first abrasion resistant layer in direct contact with the polymethylmethacrylate portion. The glazing may further include a hardcoat layer applied directly to the interior side of the polycarbonate substrate such that the hardcoat layer is the only hardcoat layer within the automotive polymer glazing. The polycarbonate portion of the film and the exterior side of the polycarbonate substrate may be in direct contact with each other. The glazing may further include a second abrasion resistant layer in direct contact with the hardcoat layer on the interior side. The first, second, or both abrasion resistant layers may include silicon. The first abrasion resistant layer and the exterior side may sandwich the co-extruded film. The first and second abrasion resistant layers may sandwich the co-extruded film, the polycarbonate glazing substrate, and the hardcoat layer therebetween. The automotive polymeric glazing is free from a hardcoat layer on the exterior side of the polycarbonate substrate.

In a yet another embodiment, a method of forming an automotive polymeric glazing is disclosed. The method may include inserting a co-extruded polymethylmethacrylate/polycarbonate film into a mold to produce a molded film having polymethylmethacrylate and polycarbonate portions. The method may further include injection molding a polycarbonate glazing substrate directly onto the polycarbonate portion of the film. The method may include applying a hardcoat layer directly onto the polycarbonate glazing substrate such that the co-extruded film and the hardcoat layer sandwich the polycarbonate substrate therebetween, and the polymeric glazing is free from additional hardcoat layers. The method may also include depositing a first abrasion resistant layer directly onto the polymethylmethacrylate portion of the co-extruded film. The polymeric glazing is free from additional layers between the co-extruded film and the first abrasion resistant layer. The method may further include depositing a second abrasion resistant layer onto the hardcoat layer. The first abrasion layer, the second abrasion resistant layer, or both may be formed by a plasma coating process. The co-extruded layer may be insert-molded during the injection molding step.

### BRIEF DESCRIPTION OF THE DRAWINGS

FIG. 1 depicts a perspective schematic view of an example vehicle having a polymeric glazing according to one or more embodiments;

FIG. 2 depicts a schematic cross-sectional view of the glazing in a section taken along the lines 2,3-2,3;

FIG. 3 depicts an alternative schematic cross-sectional view of the glazing in a section taken along the lines 2,3-2,3; and

FIG. 4 schematically illustrates a series of manufacturing steps for production of the polymeric glazing.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except where expressly indicated, all numerical quantities in this description indicating dimensions or material properties are to be understood as modified by the word “about” in describing the broadest scope of the present disclosure.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Reference is being made in detail to compositions, embodiments, and methods of the present invention known to the inventors. However, it should be understood that disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention.

The description of a group or class of materials as suitable for a given purpose in connection with one or more embodiments of the present invention implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Automotive glazings include windscreens or windshields, side and rear windows, quarter windows, and glass roof panels such as sunroofs and moon roofs on a vehicle. Historically, most of the vehicular windows were made from glass. Nowadays, most vehicles include laminated glass glazings. For example, a typical windshield includes a polyvinylbutyral (PVB) sheet laminated between two glass panels. The PVB increases the driver and passenger safety as the glazing does not shatter into sharp pieces in case of an impact. The PVB may also reduce noise transmission.

A need for continuous improvement in fuel economy and safety has led to the development of polymeric glazings which enable weight reduction of the glazing components by about 30 to 50% when compared to conventional laminated and tempered glass windows. Polymeric glazings may thus improve fuel economy while providing exceptional optics and impact resistance. In addition to lower weight, polymeric glazings are attractive because of current market trends demanding integrated, stylized glazing surfaces.

The polymeric glazings are typically injection molded. The injection molding process typically enables achieving high quality optics and a relatively easy integration of desirable parts and mold-in features into the glazing. Most of the polymer glazings incorporate PC which is relatively expensive. But PC has many advantages which make its use worthwhile, besides the ability to incorporate parts within the PC during the molding process. For example, PC has excellent impact resistance which may reduce incidence of glazing breakage, improve security, and potentially deter theft.

It remains to be a challenge, however, to produce a PC glazing which would be durable and scratch resistant. PC is very susceptible to UV degradation and to mechanical damage such as scratching. To improve UV resistance, various layers are added to the PC layer such that a laminated PC glazing is formed. The most outer layer of the laminated glazing may be a hardcoat. Alternatively, the hardcoat may be just one of the layers included on the side of the substrate which faces exterior when installed in the vehicle. While a typical hardcoat may be capable of shielding PC from UV radiation, the hardcoat itself typically does not have long-term durability. A typical hardcoat micro-cracks and delaminates from adjacent sublayers within the laminated glazing when subjected to a prolonged UV exposure. The micro-cracking and delamination reduces the ability to see through the glazing over time and becomes unsuitable for use in the areas of the vehicle which need to maintain good optical quality over time.

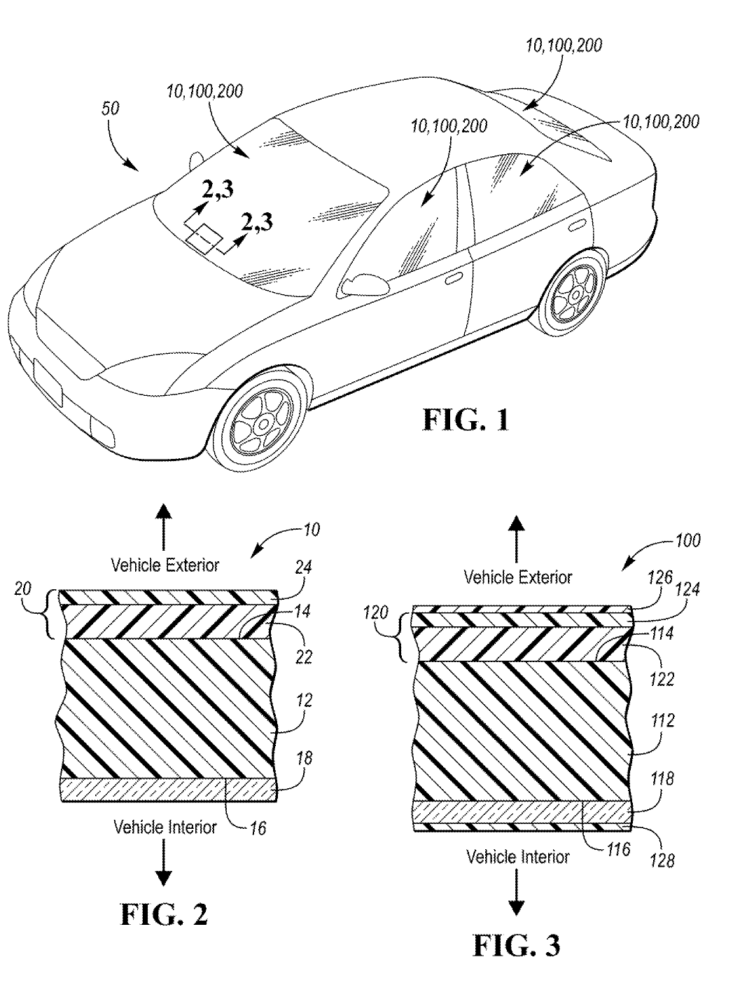

Thus, there is a need for a polymeric glazing which would solve one or more problems described above. According to one or more embodiments, a vehicular polymer glazing 10 is disclosed. Non-limiting example types of vehicles in which the polymer glazing 10 may be incorporated include land vehicles such as automobiles, buses, vehicles for transportation of goods, motorcycles, off-road vehicles, tracked vehicles, trains, amphibious vehicles, watercrafts, or the like. An example vehicle body 50 incorporating the polymer glazing 10 is depicted in FIG. 1. The polymer glazing 10 may be used as a windshield, a rear window, a side window, a quarter window, or a roof panel.

The polymer glazing 10 is laminated and includes several layers. FIG. 2 depicts an example stratification of the glazing 10 layers. The glazing 10 includes a PC glazing substrate 12 having an interior vehicle side 16 and an exterior vehicle side 14. Each side includes different layers. For example, the interior side 16 of the substrate 12 includes a hardcoat layer 18. The hardcoat layer 18 is in direct contact with the substrate 12. In addition, by including the hardcoat layer 18 on the interior side of the substrate 12, the hardcoat layer 18 is protected from the direct UV radiation when compared to the application in which a hardcoat layer forms the most exterior portion of the laminated glazing. As a result, the hardcoat layer 18 does not delaminate from the adjacent layer(s) and does not succumb to micro-cracking as only a minimal amount of UV radiation enters the interior side 16.

There is no hardcoat layer 18 provided on the exterior side 14. As such, the hardcoat layer 18 on the interior side 16 is the only hardcoat layer within the glazing 10. The glazing 10 is thus free from a hardcoat layer 18 on the exterior side 14 of the vehicle which would be prone to development of internal stresses as a result of the UV radiation.

On the exterior side 14, the substrate 12 is adjacent to a co-extruded layer 20 of PC and polymethylmethacrylate (PMMA). The co-extruded layer 20 may form the outer-most or the exterior-most layer of the laminated glazing 10. The co-extruded layer 20 may prevent UV degradation of the glazing 10. The co-extruded layer 20 includes a PC portion 22 and a PMMA portion 24. The PC portion 22 and the exterior vehicle side 14 may be in direct contact with each other such that the PC of the substrate 12 and the PC portion 22 of the co-extruded layer 20 are in direct contract with each other. The PMMA portion 24 may thus form the exterior-most portion of the glazing 10 and be in direct contact with the atmosphere when installed in a vehicle. Such arrangement provides an increased UV protection to the glazing 10 as the PMMA portion 24 serves as a UV resistant buffer to the underlying layers of PC. PC has better impact resistance but lower UV resistance than PMMA.

In an alternative embodiment, depicted in FIG. 3, a glazing 100 includes additional layer(s) when compared to glazing 10. Specifically, the glazing 100 includes the PC glazing substrate 112, which has an interior side 116 and an exterior side 114. The interior side 116 is in direct contact with a hardcoat layer 118 while the exterior side 114 is in direct contact with a co-extruded film 120 including a PC portion 122 and a PMMA portion 124. In addition, one or two abrasion resistant layers 126, 128 are included in the glazing 100. An abrasion resistant layer 126, 128 may be in direct contact with the PMMA portion 124 of the film 120 on the exterior side 114, the hardcoat layer 118 on the interior side 116, or both. The abrasion resistant layer may be a first abrasion layer 126 or a second abrasion layer 128. When the first abrasion resistant layer 126 is in direct contact with the PMMA portion 124 of the film 120 on the exterior side 114, the first abrasion resistant layer 126 forms the exterior-most portion of the glazing 100 and is in direct contact with the atmosphere when installed in a vehicle. The second abrasion layer 128 is in direct contact with the hardcoat layer 118 and is the interior-most portion of the glazing 100. The first abrasion layer 126 and the second abrasion layer 128 are optional. In one or more embodiments, the glazing 100 may include the first abrasion layer 126 but the second abrasion layer 128 may be absent. In another embodiment, the glazing 100 may contain both the first and second abrasion layers 126, 128.

In a yet alternative embodiment, a primer may be included between the substrate and the hardcoat layer. Any suitable primer may be used.

Each layer, portion, film, or the like described above may include one or more sublayers. The number of sublayers may differ depending on specific requirements of an application. The number of sublayers may be the same or differ in the same type of layer on the interior side and the exterior side of the PC glazing substrate. The number of sublayers may be 1, 2, 3, 4, 5, 6, 7, 8, 9, 10, 12, 14, 15, 18, 20, or more.

The thickness of individual layers depends on a specific application. Example thicknesses of the layers include a PC glazing substrate having from about 3 to 8 mm, 3.5 to 6 mm, or 4 to 5 mm. The co-extruded film may have a thickness of about 350 to 450 μm, 370 to 420 μm, or 390 to 410 μm. The hardcoat layer may be 2 to 10 μm, 3 to 8 μm, or 4 to 7 μm thick. The abrasion resistant layer may have a thickness of about 1 to 10 μm, 2 to 7 μm, or 4 to 5 μm. The thickness of each abrasion resistant layer may be the same or different. A thickness of each sublayer may be the same or different. A thickness of a sublayer may be from about 0.01 μm to 5 mm, 0.1 μm to 2 mm, or 1 μm to 1 mm. A thickness of a layer or a sublayer may be uniform throughout the layer or sublayer. Alternatively, the thickness may fluctuate throughout the layer.

The thickness of each layer may be expressed as a percentage of the entire glazing thickness. The PC glazing substrate may form about 89 to 95% of the entire glazing thickness, the co-extruded film may form about 5 to 11% of the entire glazing thickness, the hardcoat may form about 0.06 to 0.2%, and each abrasion layer, if included, may be from 0.03 to 0.2% of the entire glazing thickness. The PC portion may form about 90 to 95% and the PMMA portion may form about 5 to 10% of the overall co-extruded film thickness.

The polycarbonate glazing substrate may include polycarbonate having a purity level suitable for use in optical vehicular applications having high transmission of visible light, low color, high strength, high toughness, high heat resistance, and good dimensional and color stability. The polycarbonate glazing substrate may be a pure polycarbonate. Alternatively, the polycarbonate glazing substrate may include additional components improving one or more properties of the substrate. In addition, other compounds such as UV stabilizers may be added to sustain exposure to UV radiation for a longer period of time. Another example type of a compound added may be a mold release agent or a lubricant which makes processing easier. Yet another example type of materials included may be nanoparticles such as nanoclay or metal oxide particles to increase moisture, solvent, and/or abrasion resistance. Dyes, pigments, or a combination thereof may be added to change the visible and infra-red transmittance, color, or both.

The co-extruded layer includes PC and PMMA. Besides the two polymers, additional compounds may be added into each such as UV stabilizers or compounds that improve adhesion of the abrasion resistant layer to the PMMA layer.

The hardcoat layer may include silicone. The hardcoat layer may include polysiloxane(s), polyurethane(s), the like, or a combination thereof. The hardcoat layer has a chemical composition different from any other layer and/or sublayer of the glazing.

The first, second, or both abrasion resistant layers have a glass-like surface. The term “glass-like” relates to having optical properties, physical properties, chemical properties, or a combination thereof of glass. The abrasion resistant layer(s) are harder than the hardcoat layer such that hardness of the abrasion resistant layer(s) is greater than hardness of the hardcoat layer, as measured on a Mohs scale. The abrasion resistant layer(s) may be made from a material which has excellent transparency and visible light transmission. Such material may include silicon, carbon, hydrogen, and/or other elements. Such material may include organic based silicate(s). The abrasion resistant layer(s) may include various oxides, fluorides, nitrides, carbides, sulfides, selenides, titanates such as aluminum oxide, magnesium oxide, scandium oxide, silicon monoxide, silicon dioxide, hafnium oxide, tantalum oxide, titanium oxide, tin oxide, indium tin oxide, yttrium oxide, zinc oxide, zinc selenide, zirconium oxide, silicon nitride, boron nitride, silicon oxy-nitride, barium fluoride, lanthanum fluoride, magnesium fluoride, silicon oxy-carbide, silicon carbide, zinc sulfide, zinc selenide, zirconium titanate, the like, or a combination thereof.

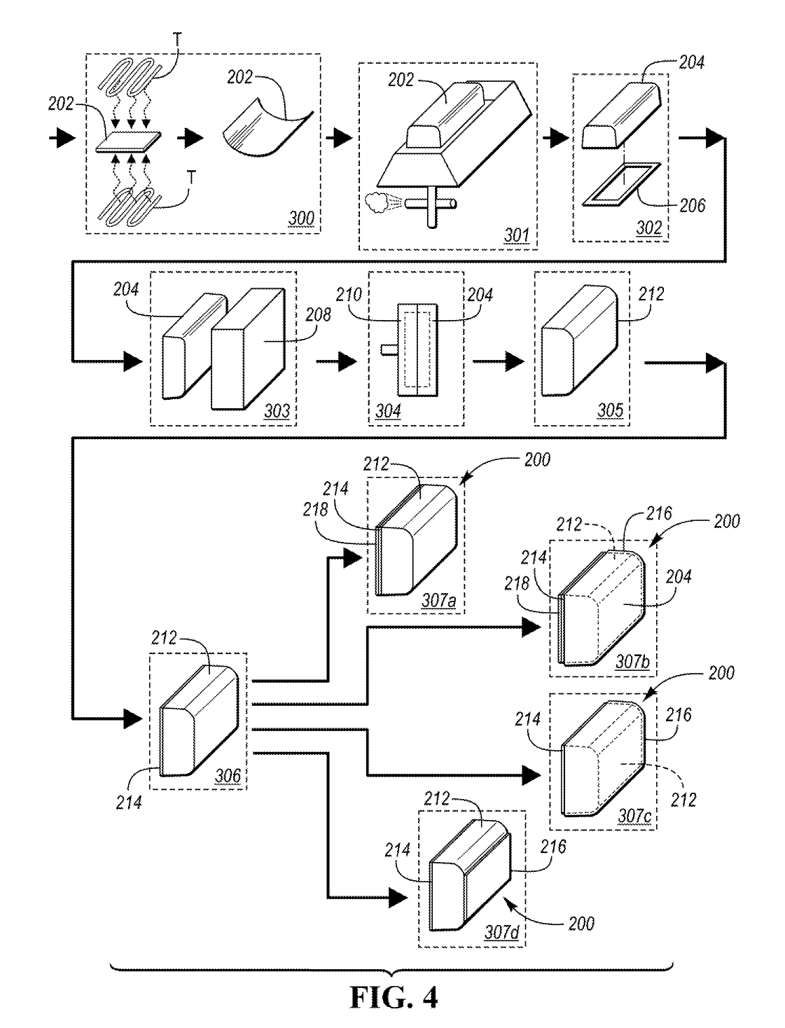

A method of producing the glazing 10, 100, 200 is also disclosed. While in the FIG. 4, the glazing and its components are denoted as a glazing 200, the method described herein is applicable to any glazing described herein. The method includes forming a PC-PMMA film or layer by co-extruding a PC material and PMMA material to form a sheet 202 having a PC portion and a PMMA portion such that both portions are in intimate contact with each other along the entire surface area of the sheet. At step 300, a PC/PMMA sheet 202 is heated and softened so that the sheet 202 becomes pliable. The method further includes, in step 301, pulling vacuum on the pliable sheet 202 to form a desirable shape of the co-extruded film 204. The shaped co-extruded film 204 may be trimmed at step 302 to remove one or more excess portions 206.

At step 303, the co-extruded film 204 may be inserted into a mold 208. Subsequently, at step 304, a PC glazing substrate 210 is injection-molded over the shaped co-extruded film 204 such that the PC portion of the co-extruded film 204 is in direct contact with the PC glazing substrate 210. Specifically, the PC portion of the co-extruded film 204 is in direct contact with the exterior side of the PC glazing substrate 210, as is illustrated in FIGS. 2 and 3. At step 305, the PC glazing substrate injection molded over the co-extruded film part 212 is removed from the mold 208. Injection-molding the PC glazing substrate 210 over the shaped co-extruded film 204 presents several manufacturing advantages. For example, no wet coat is required, no primer coating is required, and curing time of a wet coat or the primer which would otherwise be present is avoided.

At step 306, the method includes applying the hardcoat layer 214 onto the part 212 such that the interior side of the PC glazing substrate 210 is in direct contact with the hardcoat layer 214. Alternatively, a primer may be first applied onto the PC glazing substrate 210 and baked, followed by application of the hardcoat layer 214 onto the primer. The hardcoat layer 214 may be applied by dip coating, flow coating, spraying, or molding. The hardcoat layer 214 may be subsequently thermo-cured or UV-cured. The hardcoat layer 214 may be applied as a coating, completely or partially covering the interior side of the PC glazing substrate 210. The method may include applying only a single hardcoat layer 214 within the glazing 200. The method may include applying a hardcoat layer 214 directly onto the PC glazing substrate 210 of the part 212 such that the co-extruded film 204 and the hardcoat layer 214 are sandwiching the PC glazing substrate 210 therebetween. The hardcoat layer 214 may be applied as a liquid and subsequently cured. The curing temperature depends on the coating's chemistry.

Optionally, at steps 307a-307d, one or more abrasion resistant layers, specifically a first abrasion layer 216, a second abrasion layer 218, or both, may be applied as the exterior-most and/or interior-most layers/coatings of the glazing 200. In step 307a, the method may include applying the second abrasion resistant layer 218 directly onto the hardcoat layer 214. Alternatively, at step 307b, the method may include applying the first abrasion resistant layer 216 directly onto the PMMA portion of the co-extruded film 204 of the part 212 and a second abrasion layer 218 directly onto the hardcoat layer 214. Alternatively, the method may include applying the first abrasion resistant layer 216 onto the PMMA portion of the co-extruded film 204 of the part 212, but not applying any abrasion resistant layer on the hardcoat layer 214, as step 307c illustrates.

The method may include applying the abrasion resistant layer(s) 216, 218 onto the entire surface area of the hardcoat layer 214 and/or the PMMA portion of the co-extruded film 204 as in steps 307a-c. Alternatively, the method may include applying the abrasion resistant layer(s) 216, 218 only on a portion of the PMMA portion of the co-extruded film 204 and/or the hardcoat layer 214, as is depicted in step 307d. For example, the periphery of the PMMA portion of the co-extruded film 204 and/or the hardcoat layer 214 may be left abrasion resistant layer-free while the remainder of the surfaces of the layers 204, 214 may be coated with the abrasion resistant layer material. About 50 to 100%, 60 to 99%, or 70 to 95% of the PMMA portion of the co-extruded film 204 and/or the hardcoat layer 214 may be coated with the abrasion resistant layer(s) 216, 218, or both. Due to the varying shape of the desired glazing, the first and second abrasion resistant layers 216, 218 may come in contact with each other or come to close proximity of each other.

The abrasion resistant layers 216, 218 may be applied by plasma enhanced chemical vapor deposition, expanding thermal plasma, ion assisted plasma deposition, magnetron sputtering, electron beam evaporation, ion beam sputtering, physical vapor deposition, or the like. If the first and second abrasion resistant layers 216, 218 are being applied, the application of both abrasion resistant layers 216, 218 may be performed at the same time.

The method may include applying at least some of the layers, portion, films described above as one or more sublayers. The method may include application of the layers, portions, films above in such a way that the stratification of layers is as displayed in FIGS. 2 and 3. The glazing 10 thus may consist of the PC glazing substrate 12 in direct contact with the co-extruded film 20 on the exterior side 14 and the hardcoat layer 18 on the interior side 16. The glazing 100 may consist of the second abrasion resistant layer 128 which is in direct contact with the interior surface of the vehicle body. The first abrasion resistant layer 126 is in direct contact with the PMMA portion 124 of the co-extruded film 120. The PMMA portion 124 is co-extruded with the PC portion 122 of the co-extruded film 120, which is in direct contact with the PC glazing substrate 112, specifically with the exterior side 114 of the PC glazing substrate 112. The interior side 116 of the PC glazing substrate 112 is in direct contact with the hardcoat layer 118. The hardcoat layer 118 is in direct contact with the second abrasion resistant layer 128, which is the outer-most layer of the glazing 200 on the interior side of the vehicle. No additional layers have to be included in the glazing 10, 100 to provide desired optical performance, UV resistance, abrasion resistance, and durability.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A polymeric glazing of a vehicle comprising:
a polycarbonate glazing substrate having interior and exterior vehicle sides;
a hardcoat layer applied directly to the interior vehicle side; and
a co-extruded film, having polycarbonate and polymethylmethacrylate portions, in direct contact with the exterior vehicle side such that the polymeric glazing lacks a hardcoat layer outside the exterior vehicle side and the polymethylmethacrylate portion forms an outer-most layer of the polymer glazing.

2. The glazing of claim 1, wherein the polycarbonate portion of the film and the exterior vehicle side of the polycarbonate substrate are in direct contact with each other.

3. The glazing of claim 1, further comprising an abrasion resistant layer in direct contact with the hardcoat layer on the interior side, an abrasion resistant layer in direct contact with the polymethylmethacrylate portion of the film on the exterior side, or both.

4. The glazing of claim 3, wherein the abrasion resistant layer comprises silicon.

5. The glazing of claim 1, wherein the polymethylmethacrylate portion forms about 5% to 10% of an overall thickness of the co-extruded film.

6. The glazing of claim 3, wherein the abrasion resistant layer on the exterior side and the hardcoat layer on the interior side sandwich the polycarbonate glazing substrate and the co-extruded film therebetween.

7. The glazing of claim 1, wherein the hardcoat layer is a single hardcoat layer on the interior side.

8. An automotive polymeric glazing comprising:
a polycarbonate glazing substrate having interior and exterior sides;
a co-extruded film, having polymethylmethacrylate and polycarbonate portions, in direct contact with the exterior side;
a first abrasion resistant layer in direct contact with the polymethylmethacrylate portion; and
a hardcoat layer applied directly to the interior side such that the hardcoat layer is the only hardcoat layer within the automotive polymer glazing.

9. The glazing of claim 8, wherein the polycarbonate portion of the film and the exterior side of the polycarbonate substrate are in direct contact with each other.

10. The glazing of claim 8, further comprising a second abrasion resistant layer in direct contact with the hardcoat layer on the interior side.

11. The glazing of claim 10, wherein the first, second, or both abrasion resistant layers comprise silicon.

12. The glazing of claim 8, wherein the first abrasion resistant layer and the exterior side of the polycarbonate substrate are sandwiching the co-extruded film.

13. The glazing of claim 10, wherein the first and second abrasion resistant layers are sandwiching the co-extruded film, the polycarbonate glazing substrate, and the hardcoat layer therebetween.

14. The glazing of claim 8, wherein the automotive polymeric glazing is free from a hardcoat layer on the exterior side.

15. A method of forming an automotive polymeric glazing comprising:
inserting a co-extruded polymethylmethacrylate/polycarbonate film into a mold to produce a molded film having polymethylmethacrylate and polycarbonate portions;
injection molding a polycarbonate glazing substrate directly onto the polycarbonate portion of the film; and
applying a hardcoat layer directly onto the polycarbonate glazing substrate such that the co-extruded film and the hardcoat layer sandwich the polycarbonate substrate therebetween, and the polymeric glazing is free from additional hardcoat layers.

16. The method of claim 15, further comprising depositing a first abrasion resistant layer directly onto the polymethylmethacrylate portion.

17. The method of claim 16, wherein the polymer glazing is free from additional layers between the co-extruded film and the first abrasion resistant layer.

18. The method of claim 16, further comprising depositing a second abrasion resistant layer onto the hardcoat layer.

19. The method of claim 18, wherein the first abrasion layer, the second abrasion resistant layer, or both are formed by a plasma coating process.

20. The method of claim 15, wherein the co-extruded layer is insert-molded during the injection molding step.
